(19) United States
(12) Patent Application Publication
(10) Pub. No.: US 2013/0113369 A1
(43) Pub. Date: May 9, 2013

(54) LED PACKAGE MODULE

(71) Applicant: Shu-Mei KU, Zhongli City (TW)

(72) Inventor: Kuo-Feng PENG, Zhubei City (TW)

(73) Assignee: Shu-Mei KU, Zhongli City (TW)

(21) Appl. No.: 13/668,007

(22) Filed: Nov. 2, 2012

(30) Foreign Application Priority Data
Nov. 4, 2011 (TW) 100140272

(51) Int. Cl. H05B 33/00

(52) U.S. Cl. 313/512

(57) ABSTRACT

An LED package module includes a metal board, a circuit board, a plurality of chips, a plurality of wires and a molding component. The metal board has a plurality of metal pads protruding from an upper surface of the metal board. The circuit board directly stacks on whole of the upper surface of the metal board, wherein the metal pads are corresponding to and penetrate through a plurality of openings provided in the circuit board; and the upper surface of the metal pads is either at the same horizontal level as the upper surface of the circuit board or protruding from the upper surface of the circuit board. The chips respectively are arranged on the metal pads. The wires electrically connect the chips and the circuit board. The molding component covers each chip, the metal pads, wires and at least a part of the circuit board.

### BACKGROUND OF THE INVENTION

1. Field of the Invention

The present invention is directed to an LED package module, particularly directed to an LED package module using a COB (chip on board) process.

2. Description of the Prior Art

LED (light-emitting diode) is provided with advantages such as being long-lasting, power-saving and highly durable; therefore, lighting apparatuses thereof have become a trend for saving energy and environmental protection and will be widely applied in the future. In general cases for high-luminescence LED lighting devices, lighting modules, usually including a plurality of LED lamps, are directly soldered on ordinary circuit boards or aluminum substrates. Additional heating dissipating elements, such as heat sink fins installed under the substrate, may be configured for improving effects in heat dissipation. However, in addition to issues of heat dissipation, common LED lighting devices provided with lighting collimation properties fail to achieve wide lighting angles in comparison to 270 degrees for ordinary bulbs available at present. Hence, it is now an important goal to solve issues regarding heat dissipation and lighting collimation of LED lighting devices.

### SUMMARY OF THE INVENTION

To solve the above-mentioned problems, one objective of the present invention is directed to providing an LED package module having a metal plate covering whole of the lower surface of the circuit board and dissipating heat in a directly downward manner.

To achieve above objectives, an LED package module according to one embodiment of the present invention includes a metal board, a circuit board, a plurality of chips, a plurality of wires and a molding component. The metal board has a plurality of metal pads protruding from an upper surface of the metal board. The circuit board directly stacks on whole of the upper surface of the metal board, wherein the metal pads are corresponding to and penetrate through a plurality of openings provided in the circuit board; and the upper surface of the metal pads is either at the same horizontal level as the upper surface of the circuit board or protruding from the upper surface of the circuit board. The chips respectively are arranged on the metal pads. The wires electrically connect the chips and the circuit board. The molding component covers each chip, the metal pads, wires and at least a part of the circuit board. Other advantages of the present invention will become apparent from the following descriptions taken in conjunction with the accompanying drawings wherein certain embodiments of the present invention are set forth by way of illustration and examples.

### BRIEF DESCRIPTION OF THE DRAWINGS

The foregoing aspects and many of the accompanying advantages of this invention will become more readily appreciated as the same becomes better understood by reference to the following detailed descriptions, when taken in conjunction with the accompanying drawings, wherein:

FIGS. 1A, 1B and 1C are schematic diagrams illustrating an embodiment of the present invention;

FIG. 2 is a schematic diagram according to one embodiment of the present invention;

FIGS. 3A and 3B are schematic diagrams according to one embodiment of the present invention;

FIG. 4 is a schematic diagram according to one embodiment of the present invention; and

FIG. 5 is a partially enlarged view of one embodiment of the present invention.

### DESCRIPTION OF THE PREFERRED EMBODIMENT

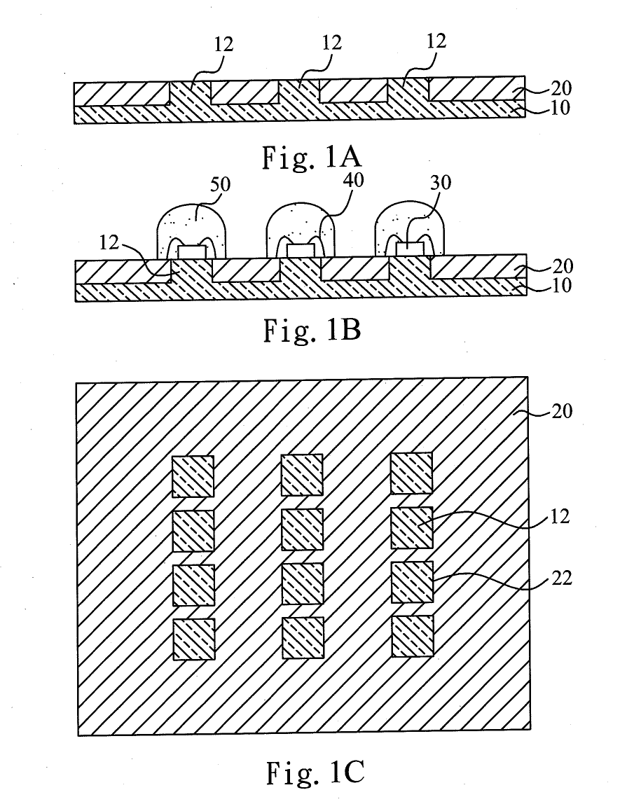

The detailed description is now illustrated as following. It is noted that the described preferred embodiments are merely illustrative instead of being used for limiting the scope of the present invention. FIGS. 1A, 1B and 1C are schematic diagrams illustrating an LED package module according to one embodiment of the present invention.

In the present embodiment, as illustrated in FIG. 1A, the LED package module includes a metal board 10. The metal board 10 has a plurality of metal pads protruding from an upper surface of the metal board 10. A circuit board 20 directly stacking on whole of the upper surface of the metal board 10. Here, as illustrated in FIG. 1C showing a top view of the circuit board and the metal board, the metal pads 12 provided in the circuit board 20 are corresponding to and penetrate through a plurality of openings 22 provided in the circuit board 20. In the present embodiment, the upper-surface of the metal pads 12 is at the same horizontal level as the upper surface of the circuit board 20. As illustrated in FIG. 1B, at least one chip 30 is respectively configured on the metal pads 12. A plurality of wires 40 respectively electrically connect the chips 30 and the circuit board 20. A molding component 50 respectively covers each chip 30, wires 40 and at least a part of the circuit board 20.

It is understood for those skilled in the art that the upper surface of the metal pads 12 is at essentially the same level as the upper surface of the circuit board 20 in the present embodiment. However, in the actual manufacturing process of stacking the metal board 10 and the circuit board 20, the upper surface of the metal pads 12 may be a little concaved provided that the lighting area of the chips 30 mounted thereon would not be interfered at all.

Next, referring to FIG. 1B and 1C, in the present embodiment, the openings 22 of the circuit board 20 and the metal pads 12 are provided in the central region of the circuit board 20. It is understood for those skilled in the art that the position or density of the metal pads 12 and chips 30 may be configured based on various demands for light sources.

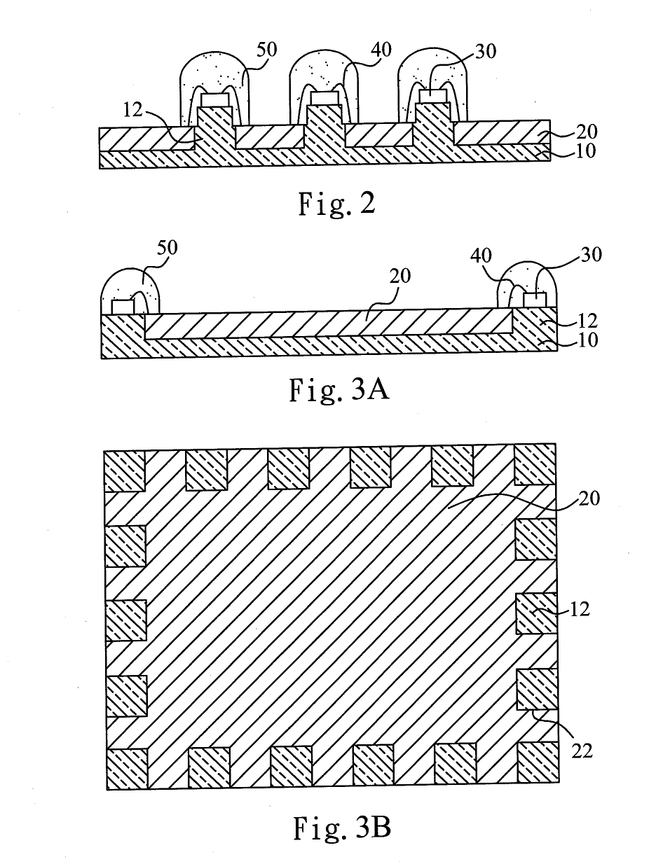

Continuing from the above description and referring to FIG. 2, in one embodiment, the metal pads 12 may penetrate through the openings 22 of the circuit board 20 (as illustrated in FIG. 1C). The upper surface of the metal pads 12 protrudes from the upper surface of the circuit board 12 so as to prevent any hindrance in front of the chips 30 and provide good lighting angles. In one embodiment, the metal board 10 and circuit board 20 have the same size and vertically stack to each other as illustrated in FIG. 1B and FIG. 2. Therefore, the metal board 10 may provide good heat dissipating capability for heat generated by the chips 30 or the internal circuits of the circuit board 20.

In the above embodiment, the size of the openings 22 of the circuit board 20 is the same as that of the metal pads 12; therefore, the metal pads 12 may penetrate through the openings 22 and be fixed.

Referring to FIG. 3A and 3B, in one embodiment, the metal pads 12 are configured at a brim region of the metal board 10. In the present embodiment, the openings 22 of the circuit board 20 is configured at a brim region of the circuit board 20 and is open so as to expose a partial lateral side of the metal pads 12 from the brim region of the circuit board 20. Wider lighting angles for the chips 30 may be provided at the brim region of the circuit board 20 in this way.

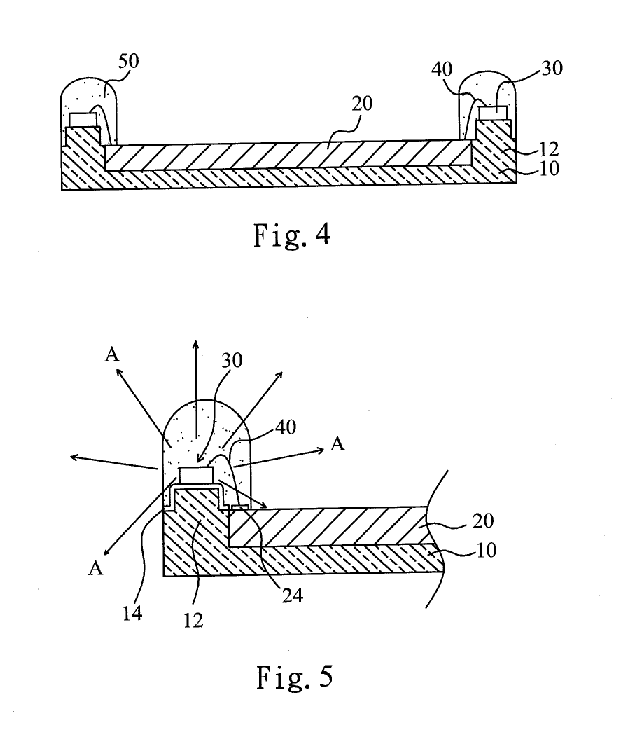

In the above embodiment, the upper surface of the metal pads 12 is at the same horizontal level as the upper surface of the circuit board 20. Continuing from the above description and referring to FIG. 4, in one embodiment, the metal pads are configured at the brim region of the circuit board 20 and expose from the partial lateral side of the metal pads 12. In addition, the metal pads 12 in the present embodiment may protrude from the upper surface of the circuit board 20. This means that the uppermost part of the metal pads 12 may be higher than the upper surface of any other region of the circuit board 20. Therefore, the lateral lighting area may be increased by configuring chips at the brim region of the LED package module and the lighting angles of the optical path A of the chips 30 may be further enhanced by elevating the height of the chips 30 with configuration of the metal pads 12, as illustrated in FIG. 5. Therefore, the present embodiment may effectively improve the conventional drawbacks of lighting collimation for LED in comparison to 270 degrees wide lighting angles for ordinary bulbs.

It is understood that chips are mounted to metal pads with a sticking agent and electrical insulation is kept between the metal board and the circuit board. Materials and processes used therein may be commonly known for those skilled in the art and hence be abbreviated.

In one embodiment, referring to FIG. 5, the upper surface of the metal board 10 may be configured with a highly reflective layer 14 made of metallic silver or other highly reflective materials. Metallic silver is capable of providing excellent reflective effect and may be provided onto the metal board 10 by electroplating.

As illustrated in FIG. 5, the wiring area of the circuit board 20 is provided with a gold-plating layer configured as soldering pads for the wires 40. The gold-plated solder pads 24 are resistant to oxidation and therefore prevent detachment of wires caused by oxidation so as to enhance the yield rate of package process. Furthermore, the wiring area on the circuit board 10 is located under the metal pads 12. Therefore, the gold-plated solder pads 24 are located underneath the lighting side of the chips 30 so as to prevent lowered lighting efficiency caused by light-absorbance of the gold-plating layer 12.

According to the above description, there is no any structure that would block the lighting of the chips, such as dam or concave cup structures, in the LED package module of the present invention. Hence, reflection for lighting is no longer necessary subsequent to lighting from the chips and it prevents from optical attenuation and lowered lighting efficiency.

To sum up, the present invention may provide better heat dissipation for LED package modules by covering the circuit board with a metal board to dissipate heat in a directly downward manner and metal pads may penetrate through the openings of the circuit board and either be at the same horizontal level as the upper surface of the circuit board or protrude from the upper surface of the circuit board. Processes and materials used in the present invention may be simplified and cost for processes and materials may be lowered since components used in the structures of the present invention are simple. Therefore, the present embodiment may effectively improve the conventional drawbacks of lighting collimation for LED in comparison to 270 degrees wide lighting angles for ordinary bulbs.

While the invention can be subject to various modifications and alternative forms, a specific example thereof has been shown in the drawings and is herein described in detail. It should be understood, however, that the invention is not to be limited to the particular form disclosed, but on the contrary, the invention is to cover all modifications, equivalents, and alternatives falling within the spirit and scope of the appended claims.

What is claimed is:

1. An LED package module, comprising:
a metal board having a plurality of metal pads protruding from an upper surface of the metal board;
a circuit board directly stacking on whole of the upper surface of the metal board, wherein the metal pads are corresponding to and penetrate through a plurality of openings provided in the circuit board; and the upper surface of the metal pads is either at the same horizontal level as the upper surface of the circuit board or protruding from the upper surface of the circuit board;
a plurality of chips respectively arranged on the metal pads;
a plurality of wires electrically connecting the chips and the circuit board; and
a molding component covering each chip, the metal pads, wires and at least a part of the circuit board.

2. The LED package module as claimed in claim 1, wherein the size of the metal board equals to that of the circuit board.

3. The LED package module as claimed in claim 1, wherein the size of each of the openings of the circuit board equals to that of each of the metal pads.

4. The LED package module as claimed in claim 1, wherein the upper surface of the metal pads is provided with a highly reflective layer made of metallic silver or highly reflective materials

5. The LED package module as claimed in claim 1, wherein the metal pads are configured at a brim region of the metal board.

6. The LED package module as claimed in claim 5, wherein an uppermost part of the metal pads is higher than a top surface of other regions of the metal board.

7. The LED package module as claimed in claim 1, wherein an uppermost part of the metal pads is higher than a top surface of other regions of the metal board.

8. The LED package module as claimed in claim 1, wherein the circuit board is provided with a gold-plating layer configured for soldering with the wires.
